(19) United States
(12) Patent Application Publication
(10) Pub. No.: US 2018/0062481 A1
(43) Pub. Date: Mar. 1, 2018

(54) WATER LINE ELECTRIC TURBINE GENERATOR

(71) Applicant: Matthew Aaron Alexander, Powell, WY (US)

(72) Inventor: Matthew Aaron Alexander, Powell, WY (US)

(21) Appl. No.: 15/695,875

(22) Filed: Sep. 5, 2017

Related U.S. Application Data
(62) Division of application No. 15/688,708, filed on Aug. 28, 2017.
Application No. 15/688,708 is a continuation of application No. 15/688,720, filed on Aug. 28, 2017.
(60) Provisional application No. 62/380,173, filed on Aug. 26, 2016.
(60) Provisional application No. 62/380,181, filed on Aug. 26, 2016.
(60) Provisional application No. 62/380,173, filed on Aug. 26, 2016.
(60) Provisional application No. 62/380,181, filed on Aug. 26, 2016.

(51) Int. Cl. H02K 7/18

(52) U.S. Cl. CPC H02K 7/1823; E03D 5/02

(57) ABSTRACT

A water line electric turbine generator. The water line electric turbine generator includes a housing, the housing directing the direction of water flow. The water line electric turbine generator also includes an inlet, where the inlet is configured to receive water from a water supply and permit water to enter the housing and an outlet, where the outlet is configured to supply water to an external system and permit water to exit the housing. The water line electric turbine generator further includes a rotor assembly, where the rotor assembly is located entirely within the housing, rotates due to water flow from the inlet to the outlet and converts to rotation into electrical power. The water line electric turbine generator additionally includes a power output, where the power output provides the electrical power to an external device.

### CROSS-REFERENCE TO RELATED APPLICATIONS

This application is a continuation of, and claims the benefit of and priority to, U.S. Non-Provisional patent application Ser. No. 15/688,720 filed on Aug. 28, 2017, which application is incorporated herein by reference in its entirety.

This application is a division of, claims the benefit of and priority to, U.S. Non-Provisional patent application Ser. No. 15/688,708 filed on Aug. 28, 2017, which application is incorporated herein by reference in its entirety.

U.S. Non-Provisional patent application Ser. No. 15/688,720 incorporated U.S. Non-Provisional patent application Ser. No. 15/688,708 by reference in its entirety.

U.S. Non-Provisional patent applications Ser. Nos. 15/688,720 and 15/688,708 claim the benefit of and priority to U.S. Provisional patent application Ser. No. 62/379,890 filed on Aug. 26, 2016, which application is incorporated herein by reference in its entirety.

U.S. Non-Provisional patent applications Ser. Nos. 15/688,720 and 15/688,708 claim the benefit of and priority to U.S. Provisional Patent Application Ser. No. 62/380,173 filed on Aug. 26, 2016, which application is incorporated herein by reference in its entirety.

U.S. Non-Provisional patent applications Ser. Nos. 15/688,720 and 15/688,708 claim the benefit of and priority to U.S. Provisional Patent Application Ser. No. 62/380,181 filed on Aug. 26, 2016, which application is incorporated herein by reference in its entirety.

### BACKGROUND OF THE INVENTION

One problem that is faced by people people in modern conditions is that modern toilets and bathrooms utilize old technology that requires bulky or less effective solutions that must be retrofit inefficiently to power modern toilet accessories. In particular, many bathrooms do not include power near a toilet. Thus, installation of a night light or other electrical device must be done some distance from the toilet.

Another problem is that there is an extreme amount of wasted potential energy used by every toilet flush and tank refill. That is, the water entering the toilet does so under pressure and this energy is simply wasted.

Accordingly, there is a need in the art for systems that can convert the kinetic energy of supply water to electricity for use at or near a toilet to provide power to devices such as toilet lights, toilet fans, bidets, night lights and other wall and battery powered accessories.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a water line electric turbine generator. The water line electric turbine generator includes a housing, the housing directing the direction of water flow. The water line electric turbine generator also includes an inlet, where the inlet is configured to receive water from a water supply and permit water to enter the housing and an outlet, where the outlet is configured to supply water to an external system and permit water to exit the housing. The water line electric turbine generator further includes a rotor assembly, where the rotor assembly is located entirely within the housing, rotates due to water flow from the inlet to the outlet and converts to rotation into electrical power. The water line electric turbine generator additionally includes a power output, where the power output provides the electrical power to an external device.

Another example embodiment includes a toilet electric system. The toilet electric system includes a water supply line, where the water supply line receives water from a building plumbing system. The toilet electric system also includes a toilet tank, where the toilet tank stores water for use by the toilet. The toilet electric system further includes a water line electric turbine generator. The water line electric turbine generator includes a housing, the housing directing the direction of water flow. The water line electric turbine generator also includes an inlet, where the inlet is configured to receive water from the water supply line and permit water to enter the housing and an outlet, where the outlet is configured to supply water to the toilet tank and permit water to exit the housing. The water line electric turbine generator further includes a rotor assembly, where the rotor assembly is located entirely within the housing, rotates due to water flow from the inlet to the outlet and converts to rotation into electrical power. The water line electric turbine generator additionally includes a power output, where the power output provides the electrical power to an external device.

Another example embodiment includes a toilet electric system. The toilet electric system includes a water supply line, where the water supply line receives water from a building plumbing system. The toilet electric system also includes a toilet tank, where the toilet tank stores water for use by the toilet. The toilet electric system further includes a water line electric turbine generator. The water line electric turbine generator includes a housing, the housing directing the direction of water flow. The water line electric turbine generator also includes an inlet, where the inlet is configured to receive water from the water supply line and permit water to enter the housing and an outlet, where the outlet is configured to supply water to the toilet tank and permit water to exit the housing. The water line electric turbine generator further includes a rotor assembly, where the rotor assembly is located entirely within the housing, rotates due to water flow from the inlet to the outlet and converts to rotation into electrical power. The water line electric turbine generator additionally includes a power output, where the power output provides the electrical power to a battery pack. The toilet electric system moreover includes the battery pack, where the battery pack is configured to store the electrical power as chemical energy for later use.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a water line electric turbine generator;

FIG. 2 illustrates a cross-sectional view of a water line electric turbine generator; and

FIG. 3 illustrates an example of a toilet electric system.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

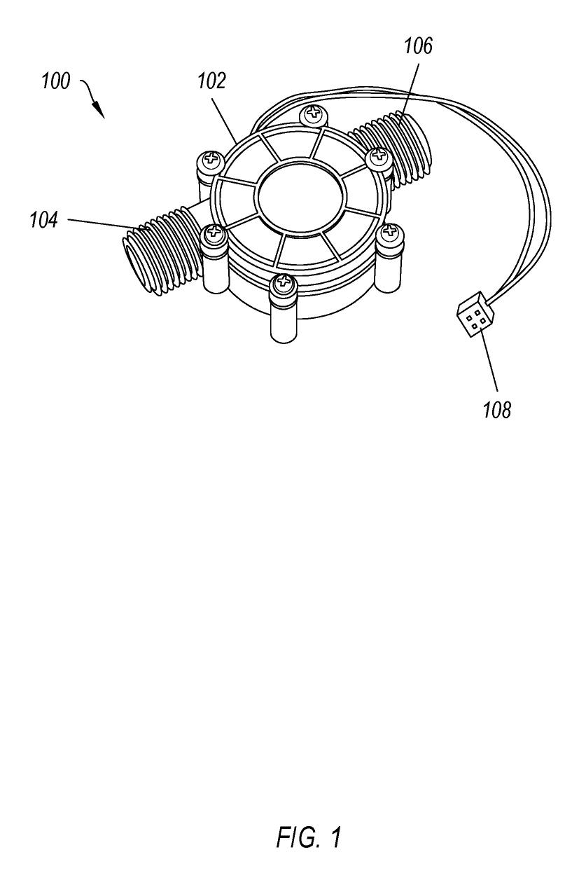

FIG. 1 illustrates an example of a water line electric turbine generator 100. The water line electric turbine generator 100 allows a user to generate electricity for any desired use using the kenetic energy of water passing through a supply line. Water is pressurized and moves through the water line to be output at specified locations. The energy of the water pressure may be partially converted to electrical energy and used to power one or more electrical devices by the water line electric turbine generator 100.

FIG. 1 shows that the water line electric turbine generator 100 can include a housing 102. In at least one implementation, the housing 102 is configured to contain the water flow within the water line electric turbine generator 100. I.e., the housing 102 must be of sufficient strength to ensure that the water line electric turbine generator 100can withstand the pressure of the water supply. Thus, the housing 102 may be constructed of any desired material, such as plastic or metal. Additionally or alternatively, the housing 102 is configured to align the other components of the water line electric turbine generator 100. I.e., the housing 102 can allow the internal and external components of the water line electric turbine generator 100 to be installed and proper spacing to be maintained among the components.

FIG. 1 also shows that the water line electric turbine generator 100 can include an inlet 104. The inlet 104 allows water from a supply pipe to be attached to the housing 102. That is, the inlet 104 allows the water line electric turbine generator 100 to be connected to a building water supply such that the water can be used to generate electricity. For example, the inlet 104 can include a female threaded attachment that matches the male threaded end of a supply hose.

FIG. 1 further shows that the water line electric turbine generator 100 can include an outlet 106. The outlet 106 connects the water line electric turbine generator 100 to the inlet of a toilet. I.e., after water has entered the housing 102 and been used in the generation of electricity, the water can pass through the outlet 106 and enter a toilet where is used in a conventional manner. For example, the outlet 106 can include a male threaded attachment that matches the female end of a toilet inlet.

FIG. 1 additionally shows that the water line electric turbine generator 100 can include a power output 108. The power output 108 can allow the produced electrical power to be output to an electrical device as desired by a user. For example, the power output 108 can include a wire, a port (such as a USB), a battery pack, etc. as described below.

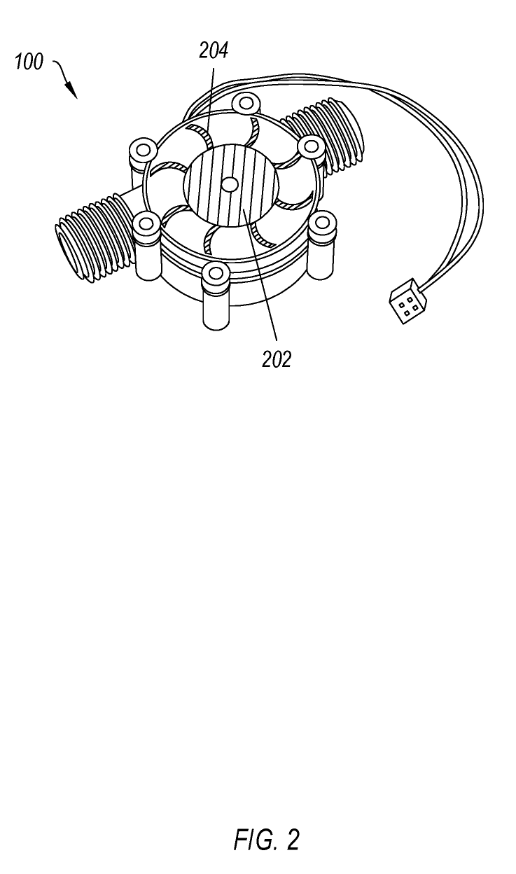

FIG. 2 illustrates a cross-sectional view of a water line electric turbine generator 100. The water line electric turbine generator takes advantage of water pressure from a water supply line and coverts some of the kinetic energy of the water to electrical power which can then be used as desired by a user.

FIG. 2 shows that the water line electric turbine generator 100 can include a turbine 202. A turbine 202 is a rotary mechanical device that extracts energy from a fluid flow and converts it into useful work. The work produced by a turbine can be used for generating electrical power when combined with a generator. Thus, the turbine 202 is a combination of a rotary assembly 204 and a generator.

FIG. 2 also shows that the water line electric turbine generator 100 can include a rotor assembly 204. The rotor assembly 204 changes the direction of flow of the water entering the water line electric turbine generator 100. The resulting impulse spins the turbine and leaves the fluid flow with diminished kinetic energy. That is, the rotor assembly 204 is rotated by the water flow through the housing 102. The result is that the moving fluid acts on the blades so that they move and impart rotational energy to the rotor assembly 204.

Rotation of the rotor assembly 204 is converted to electrical energy. A conductor moving relative to a magnetic field develops an electromotive force (EMF) in it (Faraday's Law). This EMF reverses its polarity when it moves under magnetic poles of opposite polarity. Typically, a rotating magnet, called the rotor turns via rotation of the rotor assembly 204 within a stationary set of conductors wound in coils on an iron core, called the stator. The field cuts across the conductors, generating an induced EMF (electromotive force), as the mechanical input causes the rotor to turn. The rotating magnetic field induces an AC voltage in the stator windings. The rotor's magnetic field may be produced by permanent magnets, or by a field coil electromagnet. Since the permanent magnet field is constant, the terminal voltage varies directly with the speed of the generator.

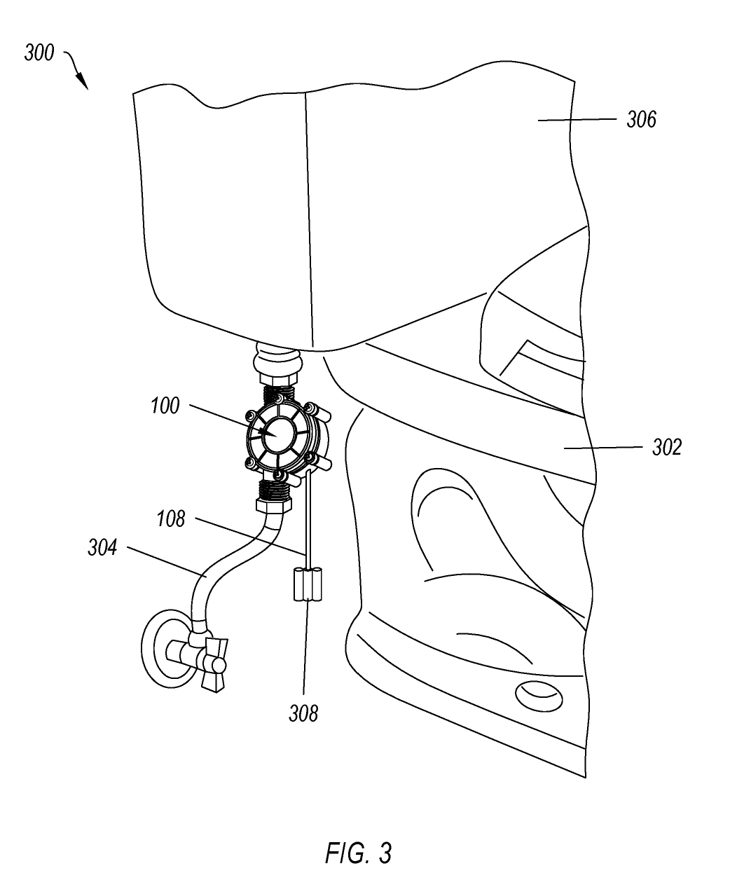

FIG. 3 illustrates an example of a toilet electric system 300. I.e., the water line electric turbine generator 100 has been attached to a toilet 302 in order to generate power for an external device. The water line electric turbine generator 100 allows a user to generate potential electricity using the potential energy of the water being pumped into a toilet tank. Water is pressurized and moves through a supply line to fill the tank of the toilet. The energy of the water pressure may be partially converted to electrical energy and used to power one or more electrical devices by the water line electric turbine generator 100.

FIG. 3 shows that the toilet electric system 300 can include a supply line 304. The supply line 304 connects the water line electric turbine generator 100 to a building water supply. I.e., the supply line 304 in a regular toilet would attach to a water supply on one end and a toilet tank 306 on the other end. However, the supply line 304 has been disconnected from the toilet tank 306 and the inlet 104 of the water line electric turbine generator 100 has been attached to the supply line 304 and the outlet 106 of the water line electric turbine generator 100 has been attached to the toilet tank 306.

FIG. 3 also shows that the toilet electric system 300 can include a battery pack 308. The battery pack 308 can store the generated electric power for later use. A battery pack 308 is a device that includes one or more electrochemical cells that convert stored chemical energy into electrical energy. A rechargeable battery includes one or more electrochemical cells and its electrochemical reactions are electrically reversible. Rechargeable batteries come in many different shapes and sizes, ranging from button cells to megawatt systems connected to stabilize an electrical distribution network. Several different combinations of chemicals are commonly used, including: lead-acid, nickel cadmium (NiCd), nickel metal hydride (NiMH), lithium ion (Li-ion), and lithium ion polymer (Li-ion polymer).

FIG. 3 further shows that the toilet electric system 300 can include the power output 108 connecting the housing 102 and the battery pack 308. The power output 108 can be wired or wireless. For example, power output 108 can include one or more wires from the housing 102 to the battery pack 308. Additionally or alternatively, the power output 108 can include an inductive charger. Inductive charging (also known as cordless charging) uses an electromagnetic field to transfer energy between two objects through electromagnetic induction. This is usually done with a charging station. Energy is sent through an inductive coupling to an electrical device, which can then use that energy to charge batteries or run the device. Induction chargers use an induction coil to create an alternating electromagnetic field from within the housing 102, and a second induction coil in the battery pack 308 takes power from the electromagnetic field and converts it back into electric current to charge the battery. The two induction coils in proximity combine to form an electrical transformer.

One of skill in the art will appreciate that the electrical connection 100 need not be permanent. For example, the electrical connection can include a plug that can be inserted into and removed from an external battery pack 308. E.g., the power output 108 can include a USB plug that can allow an external battery pack 308 to be plugged into the water line electric turbine generator 100 as desired.

One of skill in the art will further appreciate that power output 108 can be connected to an external device besides a battery pack. For example, the electrical connection can connect directly to an external device such as a light, fan, a toilet light, a night light, a bidet, a germicidal device, a dispenser, etc.

As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. Thus, the phrase “configured to” reaches well beyond merely describing functional language or intended use since the phrase actively recites an actual state of configuration.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A water line electric turbine generator, the water line electric turbine generator comprising:
a housing, the housing directing the direction of water flow;
an inlet, wherein the inlet is configured to:
receive water from a water supply; and
permit water to enter the housing;
an outlet, wherein the outlet is configured to:
supply water to an external system; and
permit water to exit the housing;
a rotor assembly, wherein the rotor assembly;
is located entirely within the housing;
rotates due to water flow from the inlet to the outlet; and
converts to rotation into electrical power; and
a power output, wherein the power output provides the electrical power to an external device.

2. The system of claim 1, wherein the rotor assembly includes one or more blades.

3. The system of claim 1, wherein the inlet is configured to attach to an external water supply.

4. The system of claim 1, wherein the inlet includes threading.

5. The system of claim 1, wherein the inlet includes a female threaded attachment.

6. The system of claim 1, wherein the outlet is configured to attach to an external system that uses water.

7. The system of claim 1, wherein the outlet includes threading.

8. The system of claim 1, wherein the inlet includes a male threaded attachment.

9. A toilet electric system, the toilet electric system comprising:
a water supply line, wherein the water supply line receives water from a building plumbing system;
a toilet tank, wherein the toilet tank stores water for use by a toilet; and
a water line electric turbine generator, wherein the water line electric turbine generator includes:
a housing, the housing directing the direction of water flow;
an inlet, wherein the inlet:
receives water from the water supply line; and
permits water to enter the housing;
an outlet, wherein the outlet:
supplies water to the toilet tank; and
permits water to exit the housing;
a rotor assembly, wherein the rotor assembly;
is located entirely within the housing;
rotates due to water flow from the inlet to the outlet; and
converts to rotation into electrical power; and
a power output, wherein the power output provides the electrical power to an external device.

10. The system of claim 9, wherein the external device includes a toilet light.

11. The system of claim 9, wherein the external device includes a night light.

12. The system of claim 9, wherein the external device includes a bidet.

13. The system of claim 9, wherein the external device includes a fan.

14. The system of claim 9, wherein the external device includes a germicidal device.

15. The system of claim 9, wherein the external device includes a dispenser.

16. The system of claim 9, wherein the external device includes a USB port.

17. A toilet electric system, the toilet electric system comprising:
a water supply line, wherein the water supply line receives water from a building plumbing system;
a toilet tank, wherein the toilet tank stores water for use by a toilet;
a water line electric turbine generator, wherein the water line electric turbine generator includes:
a housing, the housing directing the direction of water flow;
an inlet, wherein the inlet:
receives water from the water supply line; and
permits water to enter the housing;
an outlet, wherein the outlet:
supplies water to the toilet tank; and
permits water to exit the housing;
a rotor assembly, wherein the rotor assembly;
is located entirely within the housing;
rotates due to water flow from the inlet to the outlet; and
converts to rotation into electrical power; and
a power output, wherein the power output provides the electrical power to a battery pack; and
the battery pack, wherein the battery pack is configured to store the electrical power as chemical energy for later use.

18. The system of claim 17, wherein the power input includes one or more wires.

19. The system of claim 17, wherein the power output includes a wireless electrical connection.
